(19) United States
(12) Patent Application Publication
(10) Pub. No.: US 2005/0204710 A1
(43) Pub. Date: Sep. 22, 2005

(54) Device for screwing and crimping a cap on a neck

(76) Inventors: Guy Denom, Saint Seurin Sur L' Isle (FR); Jean-Marie Bourreau, Le Pizou (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/518,379

(22) PCT Filed: Jul. 1, 2003
(86) PCT No.: PCT/FR03/02030

§ 371 Date: Feb. 8, 2005

(30) Foreign Application Priority Data
Jul. 4, 2002 (FR) 0208383

(51) Int. Cl. B67B 3/20

(52) U.S. Cl. 53/490; 53/331

(57) ABSTRACT

A device including a rotating capping head with axial displacement, characterized in that the head is provided with means for screwing a cap on the neck, and means for crimping the cap beneath a crimping ring. The axial displacement includes a first axial displacement of the head activating the screwing means and a second axial displacement of the head activating the crimping means, so as to produce successively, and in one single axial displacement of the head, a screwing step and a crimping step constituting the capping process. The inventive device enables the cap to be screwed and crimped in one single step.

### FIELD OF THE INVENTION

The invention relates to the domain of capping of receptacles, particularly bottles, and typically screwing and crimping screw sealing caps on bottles with threaded necks.

### STATE OF THE ART

Caps are usually crimped using a capping head with mobile wheels that operates according to the principle described in French patent No. 978 537.

The essential elements of the crimping head include particularly:
a spring ejector provided with a profiled end piece with axial displacement due to a slide fixed to the frame of the capping machine,
a rotating ring (rotated by means not shown) with a slide as hub and on which rods are fixed, the end of each rod being fitted with a wheel free to rotate axially,
springs acting on the set of rods such that the wheels apply a radial pressure on the cap while actually crimping, or on the profiled end piece during the crimping cycle phase,
guide means.

When crimping an outer cap, the rotating ring, the rods and the wheels are all rotating, and while the end piece presses on the head of the cap, there is a relative displacement (axial) of the rotating ring, rods and wheels with respect to the assembly formed by the ejector and the skirt of the cap: gradually, the wheels that were initially bearing on the profiled end piece come into contact and bear on the skirt of the cap and crimp it.

The inventors have already improved existing crimping heads several times, firstly by modifying the profile of the wheels as described in French patent No. 2 469 379, and also by varying the hardness of the wheels, as described in French patent No. 2 675 495, and finally by varying the number and configuration of the wheels as described in French patent No. 2 710 905.

Screwing heads are also known.

Problems that Arise

Up to now, bottles with threaded necks with a metallic screw cap were sealed in two passes or two steps, with two different items of equipment:
a cap screwing step using a screwing head,
then a crimping step using a crimping head.

This invention is intended to perform the two screwing and crimping operations in a single step and with a single item of equipment, so as to reduce the capping investment, in other words the cost of capping equipment or devices, to reduce the capping time, and to reduce the size of capping equipment.

Consequently, the inventors have developed a device for performing a complete screwing and crimping operation on the sealing cap, in a single pass.

### DESCRIPTION OF THE INVENTION

According to the invention, the capping device for a neck of a receptacle with an axis of symmetry, typically a bottle, comprising an upper threaded portion with height Hf provided with at least one thread with N turns and a lower portion or crimping ring, using a screw sealing cap provided with a head and a crimpable skirt, typically metallic, comprises a capping head capable of rotating at a rotation speed Ω using a rotation means, about an axis of rotation with the said axis of symmetry, and with axial displacement so as to move the said head closer to the said neck typically fixed in the axial direction, during the said capping operation due to an axial displacement means, and is characterised in that the said head is provided with a means of screwing the said cap to the said upper threaded portion of the said neck, and a means of crimping the said skirt under the said crimping ring, the said axial displacement comprising a first axial displacement of the said head activating the said screwing means and a second axial displacement of the said head activating the said crimping means, so as to have firstly a screwing step and secondly a crimping step forming the said capping operation, or in a single axial displacement of the said head.

Thus, with the device according to the invention, a single axial displacement of the head is sufficient to successively screw and then to crimp the cap which solves the problems that arise since a single head is sufficient where two heads and two distinct items of equipment were necessary using standard equipment according to the state of the art.

### DESCRIPTION OF THE FIGURES

All the figures relate to the invention.

FIGS. 1 to 6b show diagrammatic views or sections through a vertical plane passing through the axis of rotation (20) of the capping head (2) and the axis of symmetry (71) of the neck (70) to be sealed.

FIG. 1 is a diagrammatic view of the capping device (1).

FIGS. 2 to 5 are left half-views of the capping head (2) during the different cap fitting phases, as the head (2) is lowered with respect of the neck (70) to be sealed:

FIG. 2 shows the head (2) before the beginning of screwing of the sealing cap (8) on the neck (70),

FIG. 3 shows the head (2) at the end of screwing of the cap (8), but before compression of the seal (81) in the cap,

FIG. 4 shows the head (2) after compression of the seal (81) and the beginning of tipping of the crimping arm (40),

FIG. 5 shows the head (2) at the end of crimping.

FIGS. 6a and 6b relate to the head that was made, FIG. 6a being a view of the major part of the head (2), while FIG. 6b is an enlarged view of the lower part of the head.

FIGS. 7a to 7c show diagrams related to axial displacements of the head or its different parts.

FIG. 7a shows displacements (ordinate) of the different parts of the head during a single cycle (abscissa), namely as the head is lowered and then lifted once.

FIG. 7b diagrammatically shows several cycles (3 cycles) composed of linear portions, while in FIG. 7c the head displacement is sinusoidal.

### DETAILED DESCRIPTION OF THE INVENTION

According to the invention, during the said first displacement, the said screwing means can rotate the said cap (8) with respect to the said neck (70) with a rotation speed of the said cap (8) typically close to the said rotation speed Ω of the said head (2).

As soon as the bearing part (6) comes into contact with the cap to be screwed, it drives it in rotation at speed Ω.

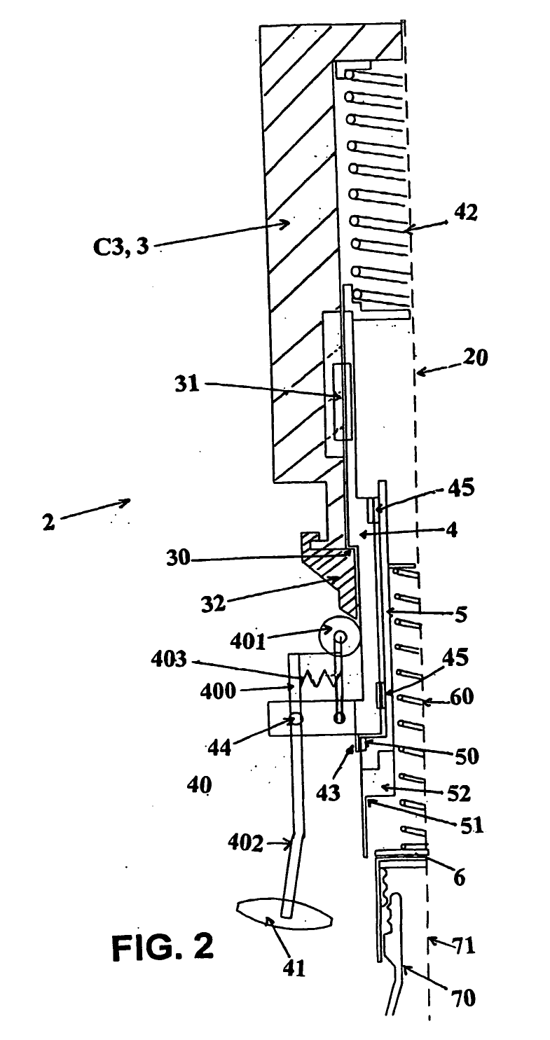

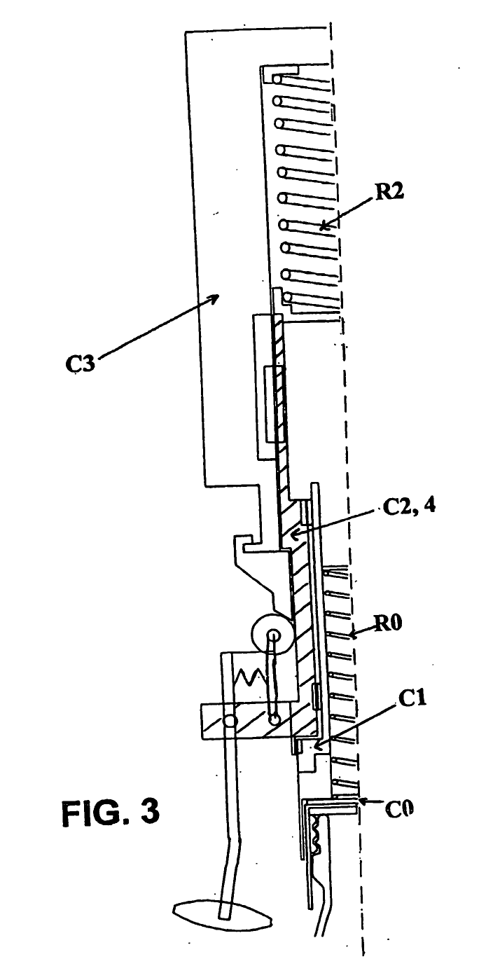

This contact may correspond to a predetermined axial force and, as illustrated particularly in FIGS. 2 and 3, to achieve this the said screwing means may comprise a means, typically a spring R0 (60) applying a force F0 on the said head (82) of the said cap (8) typically varying from 20 N to 150 N, during all or some of the said screwing step.

According to the invention, the said crimping means may include at least two arms or lifting beams (40), each arm (40) carrying a crimping roller (41) at its lower end, articulated so that it can be brought closer to the said neck (70) during the said crimping step and moved away from the said neck (70) during the said screwing step.

As shown particularly in FIGS. 3 to 5, the said head (2) may include a means, typically a spring R2 (42) for applying a force F2 on the said head (82) of the said cap (8), typically varying from 500 N to 1500 N after the said screwing step and during all or some of the said crimping step.

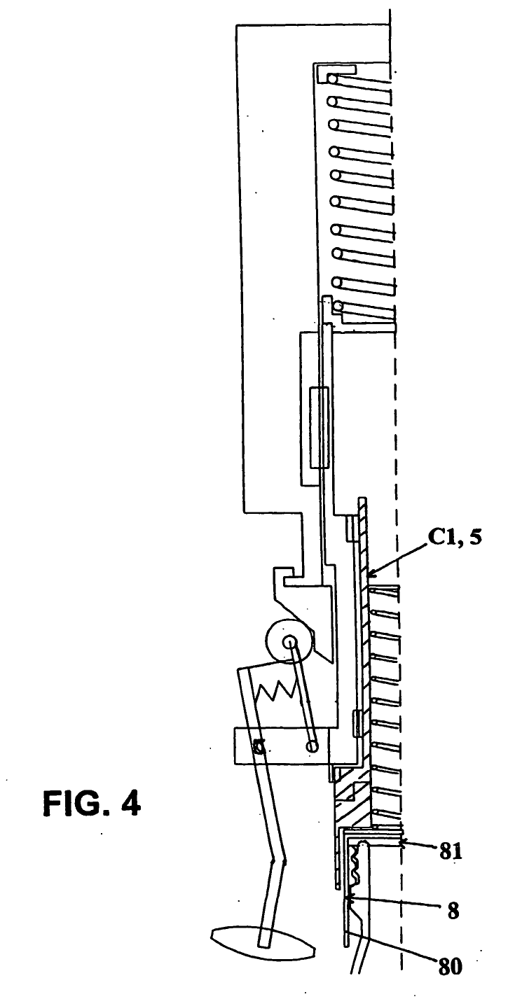

As can be seen in FIG. 4, the said means for applying the said force F2 may typically be activated before the said rollers (41) are applied in contact with the said skirt in order to crimp the said skirt (80), so as to axially compress the said cap (8) in contact with the said neck (70) and its sealing ring, particularly when the said cap (8) comprises a compressible seal (81) to be compressed before the crimping step in order to seal the said cap (8) on the said neck (70).

According to one embodiment of the invention, the said head (2) may comprise:
a) a support C3 (3), typically cylindrical, solidarised to a fixed frame (10), capable of turning about the said axis of rotation (20) with the said rotation speed Ω typically predetermined and possibly constant, and moving in the axial direction with respect to the said neck (70) with an axial displacement D3,
b) a coaxial tubular body C2 (4) internal to the said support C3 (3), but capable of moving axially with respect to the said support C3 (3) with an axial displacement D2, the said support C3 (3) comprising a lower stop (30) to limit the axial displacement of the said tubular body C2 (4) and applying a force F2 on the said tubular body C2 (4), typically using a spring R2 (42),
c) a central body C1 (5), coaxial with the said tubular body C2 (4), typically hollow, solidarised to the said tubular body C2 (4) for the said displacement D2 typically by means of a set of bearings, typically needle bearings (45), the said tubular body C2 (4) forming a hub for the said central body C1 (5) acting as an axle,
d) a means for partial coupling of the said tubular body C2 (4) and the said central body C1 (5) in rotation, rotation of the said tubular body C2 (4) only causing a rotation of the said central body C1 (5) during the said screwing step, rotation of the said central body C1 (5) possibly being interrupted by the development of an opposing torque C at the end of screwing,
e) the said central body C1 (5) comprises a bearing part C0 (6) that will cause rotation of the said cap (8) and move axially with respect to the said central body C1 (5) with a displacement D0 typically corresponding to the height of the said threaded portion (700) of the said cap (8), an upper stop (51) for the said bearing part (6) and a spring R0 (60) applying a force F0 on the said bearing part C0 (6) so as to provide coupling of the said head (2) through the said bearing part C0 (6) and the said cap (8) in rotation, and to form the said screwing means,
f) the said arms or lifting beams (40) of the said crimping means are axially fixed to the said tubular body C2 (4) and can be rotated due to a secondary rotation axis (44) typically fixed to the said tubular body C2(4).

The said crimping means may include a cam (32) axially fixed to the said support C3 (3), each of the said typically rigid arms (40) comprising an upper part (400) typically provided with a caster or a wheel or a sliding pad (401), and a roller support arm (402) supporting the said roller (41), such that the said second displacement causes a temporary cooperation of the said cam (32) and the said wheel or pad (401), bringing the said roller (41) closer to the said neck (70) for said crimping.

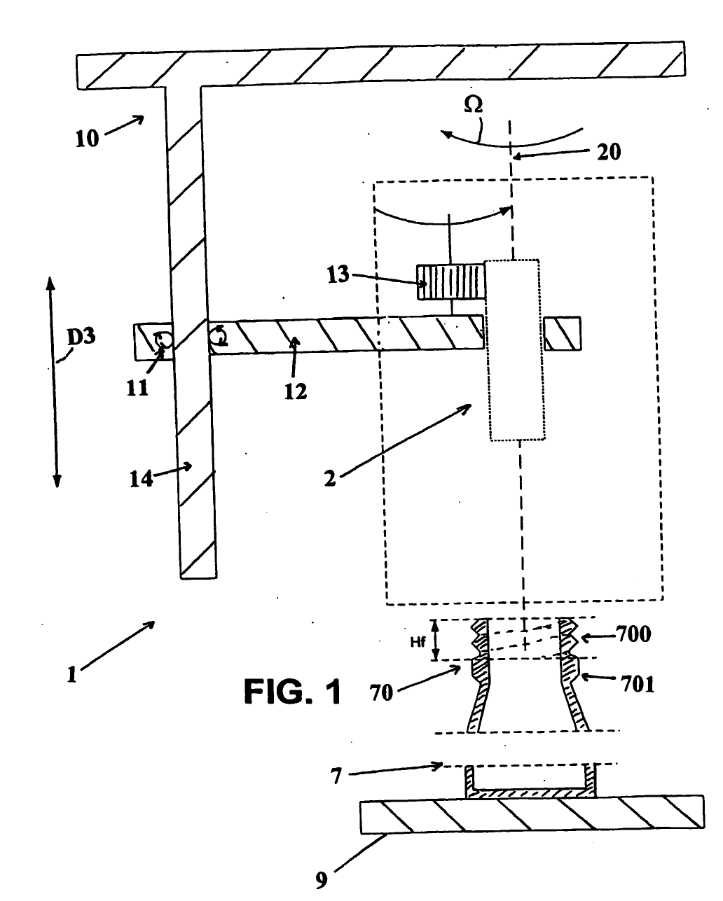

According to one embodiment of the invention illustrated diagrammatically in FIG. 1, the said support C3 (3) of the said head (2) may be solidarised to an arm (12), typically horizontal, and is free in rotation with respect to the said arm (12), the said support C3 (3) and the said arm (12) respectively forming an axle/hub assembly, the said arm (12) possibly acting as a support for a motor forming the said rotation means (13) capable of driving the said support C3 (3) in rotation.

The said arm (12) and the said fixed frame (10) may cooperate, typically using a vertical column (14) so as to assure the said axial displacement D3 of the support C3 (3) by translation of the said arm (12) in a vertical plane, typically by means of an auxiliary motor (11) acting as an axial displacement means.

But according to another embodiment of the invention (not shown in any figure), the said arm (12) may be placed onboard a rotary turret and form part of a set of n capping heads (2), where n typically varies from 2 to 12, the supports C3 (3) being engaged to a central gearwheel to rotate the said supports C3.

According to the invention, the said partial rotational coupling means of the said tubular body C2 (4) and the said central body C1 (5) may be a magnetic or electromagnetic coupling, typically by means of facing magnets (43, 50) supported by the said tubular body C2 (4) and the said central body C1 (5). These facing magnets are typically chosen such that the torque applied on the cap is equal to not more than 80% of the value of the limiting torque corresponding to irreversible deformation or destruction of the cap.

It is advantageous if at the end of the screwing step, the said bearing part C0 (6) is capable of coming into contact and stopping in contact with the said upper stop (51) so that the said central body C1 (5) and the said tubular body C2 (4) can transmit the said force F2 to the head (82) of the said cap (8).

The rotation speed Ω and displacement speed V of the said head (2) during the said first displacement may be slaved so as to satisfy the relation V=Hf.Ω/N so as to synchronise rotation of the said cap (8) and the lowering speed onto the neck (70) during the said screwing step, typical values of Hf, Ω and N being 5 mm to 20 mm for Hf, 150 rpm to 500 rpm for Ω, 0.5 to 5 for N, with the total number of rotations varying from 10 to 25. Thus, there is no risk of deformation of the threads of the caps.

Another purpose of the invention is a method of capping a bottle using the capping device (1) according to the invention using a capping head (2) screwing and crimping a screw cap (8) on the threaded neck (70) of the said bottle or receptacle (7) and in which the said bottle (7) having firstly being brought facing the said head, typically by horizontal step by step displacement, or possibly continuous displacement, the said bottle (7) and alignment of the said rotation axis (20) and the axis of symmetry (71) and held still for a time T corresponding to one capping cycle, the said head is subjected to a cyclic movement with duration T with respect to the said neck (70) typically including lowering of the said head from a high point to a low point, with a lowering time Td of the said head during which the said cap was firstly procured and placed on the said neck, the said screwing is carried out first during a time Tdv followed by the said crimping for a time Tds, the said lowering time Td being approximately equal to the time necessary to perform the said first and second displacements, followed by a rise time Tr of the said head, the said bottle after being capped being displaced and replaced by another bottle to be capped typically when the said head is at the said high point.

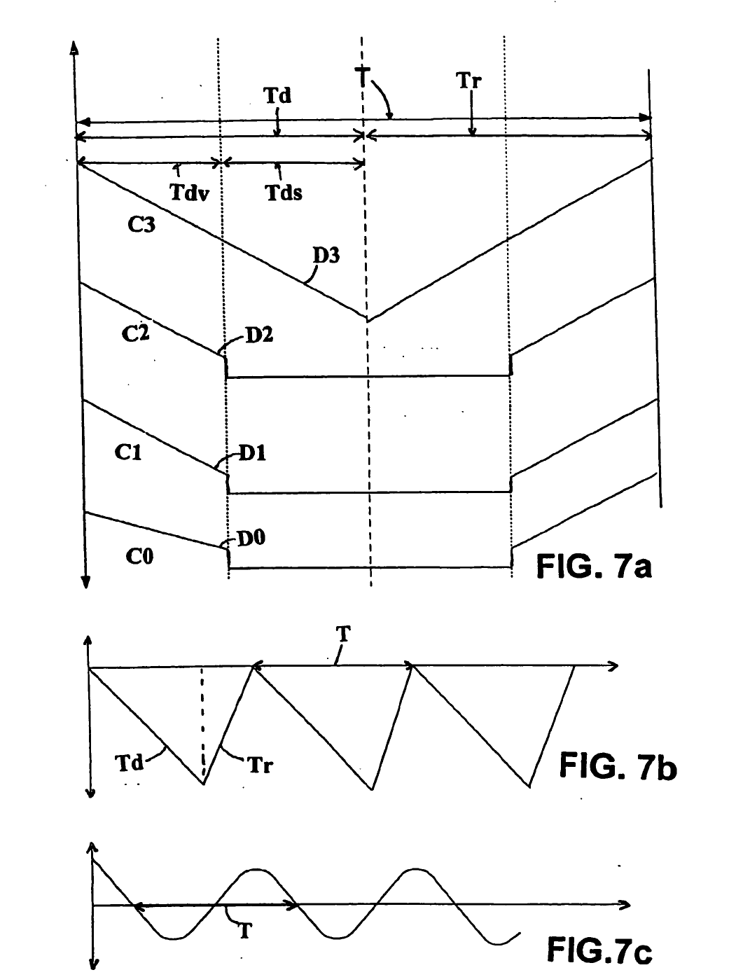

FIG. 7a diagrammatically illustrates the different displacements (ordinates) as a function of time during a cycle T (abscissa).

In this process, the said cyclic movement of the said head (2) may be a sinusoidal movement typically obtained by cooperation of a connecting rod and a crank, as illustrated in FIG. 7c. It may possibly be a continuous circular movement typically obtained using a cam.

The said cyclic movement of the said head may be a movement composed of linear parts at constant speed, typically obtained with hydraulic jacks as illustrated in FIG. 7b. In this case, the rising time Tr may be shorter than the lowering time Td, and typically less than half as long.

### Example Embodiment

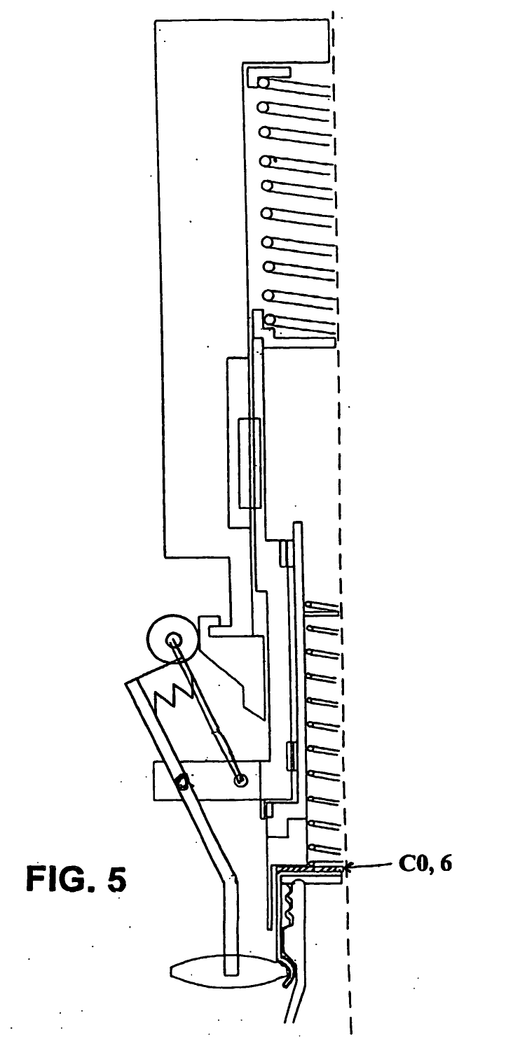

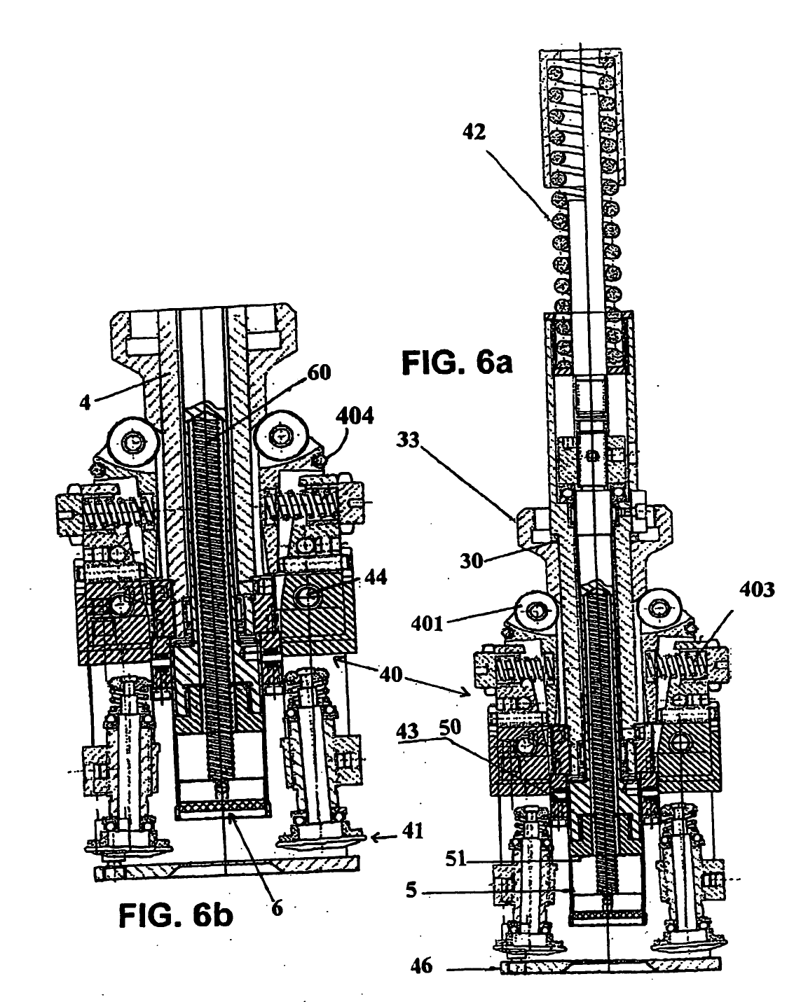

FIGS. 6a and 6b form an example embodiment of a head (2) according to the invention, FIGS. 2 to 5 being more diagrammatic and intended to explain operation of the head (2) represented in FIGS. 5a and 6b.

Marks shown in FIG. 2 have not been repeated in FIGS. 3 to 5, to avoid making FIGS. 3 to 5 unnecessarily more congested.

### ADVANTAGES OF THE INVENTION

The invention can solve the problems that arise and perform the screwing and crimping operations in a single step and with a single item of equipment.

Furthermore, although the device according to the invention is slightly more expensive than a screwing device or a crimping device, is significantly less expensive than the combined investment cost of a screwing device and a crimping device. The same is true for the maintenance cost of the device according to the invention.

The inventors have also observed that the device according to the invention can increase production rates.

Finally, the device according to the invention halves the floor space occupied by separate screwing means and capping means.

### LIST OF REFERENCES

capping device . . . 1
   Fixed frame . . . 10
   Axial displacement means (aux. motor) . . . 11
   Horizontal arm . . . 12
   Means of rotation (motor) of 2 . . . 13
   Vertical column . . . 14
Capping head . . . 2
   Rotation axis . . . 20
Support C3 . . . 3
   Lower stop . . . 30
   Coupling of 3 and 4 in rotation . . . 31
   Cam cooperating with 401 . . . 32
Tubular body C2 . . . 4
   Arms or lifting beams . . . 40
      Upper part . . . 400
      Wheel or pad . . . 401
      Roller support arm . . . 402
      Crimping spring . . . 403
      Arm return spring 40 . . . 404
   Crimping roller . . . 41
   Spring R2 . . . 42
   Partial coupling in rotation (magnets) . . . 43
   Secondary rotation axis . . . 44
   (Needle) bearings between 4 and 5 . . . 45
   Centring device . . . 46
Central body C1 . . . 5
   Partial coupling in rotation (magnets) . . . 50
   Upper stop . . . 51
   End piece adaptable to the neck . . . 52
Bearing part C0 . . . 6
   Spring R0 . . . 60
Bottle, receptacle . . . 7
   Neck . . . 70
      Threaded upper portion . . . 700
      Lower portion or ring . . . 701
   Axis of symmetry . . . 71
Sealing cap . . . 8
   Crimpable skirt . . . 80
   Compressible seal . . . 81
   Head . . . 82
Bottle, receptacle support . . . 9

1. Capping device (1) for a neck (70) of a receptacle (7) with an axis of symmetry (71), typically a bottle, comprising a threaded upper portion (700) with height Hf provided with at least one thread with N turns and a lower portion or crimping ring (701), using a screw sealing cap (8) provided with a head (82) and a metallic crimpable skirt (80), the said device (1) comprising a capping head (2) capable of rotating at a rotation speed Ω using a rotation means (13), about an axis of rotation (20) common with the said axis of symmetry (71), and with axial displacement so as to move the said capping head (2) closer to the said neck (70) typically fixed in the axial direction, during the said capping operation, characterised in that:
a) the said capping head (2) is provided with a means of screwing the said cap (8) to the said threaded upper portion (700) of the said neck (70), and a means of crimping the said skirt (80) under the said crimping ring (701), the said axial displacement comprising a first axial displacement of the said capping head (2) activating the said screwing means and a second axial displacement of the said capping head (2) activating the said crimping means,
b) the said screwing means rotates the said cap (8) with respect to the said neck (70), during the said first displacement, the said screwing means comprising a means applying a force F0 on the said head (82) of the said cap (8) varying typically from 20 N to 150 N, during all or part of the said screwing step,
so as to have a screwing step and a crimping step forming the said capping head (2).

2. Device according to claim 1 in which the said screwing means rotates the said cap (8) with a rotation speed typically close to the said rotation speed Ω of the said capping head (2).

3. Device according to claim 2, in which the said screwing means comprises a spring R0 (60) applying the said force F0 on the said head (82) of the said cap (8).

4. Device according to claim 1, in which the said crimping means includes at least two arms or lifting beams (40), each arm (40) carrying a crimping roller (41) at its lower end, articulated so that it can be brought closer to the said neck (70) during the said crimping step and moved away from the said neck (70) during the said screwing step.

5. Device according to claim 1, in which the said capping head (2) includes a means, typically a spring R2 (42) for applying a force F2 on the said head (82) of the said cap (8), typically varying from 500 N to 1500 N after the said screwing step and during all or part of the said crimping step.

6. Device according to claim 5, in which the said means for applying the said force F2 is typically activated before the said rollers (41) are applied in contact with the said skirt in order to crimp the said skirt (80), so as to axially compress the said cap (8) in contact with the said neck (70) and its sealing ring, particularly when the said cap (8) comprises a compressible seal (81) to be compressed before the crimping step in order to seal the said cap (8) on the said neck (70).

7. Device according to claim 4, in which the said capping head (2) comprises:
a) a support C3 (3), typically cylindrical, solidarised to a fixed frame (10), capable of turning about the said axis of rotation (20) with the said rotation speed Ω typically predetermined and possibly constant, and moving in the axial direction with respect to the said neck (70) with an axial displacement D3,
b) a coaxial tubular body C2 (4) internal to the said support C3 (3) and coaxial with it, but capable of moving axially with respect to the said support C3 (3) with an axial displacement D2, the said support C3 (3) comprising a lower stop (30) to limit the axial displacement of the said tubular body C2 (4) and applying a force F2 on the said tubular body C2 (4), typically using a spring R2 (42),
c) a central body C1 (5), coaxial with the said tubular body C2 (4), typically hollow, solidarised to the said tubular body C2 (4) for the said displacement D2 typically by means of a set of bearings, typically needle bearings (45), the said tubular body C2 (4) forming a hub for the said central body C1 (5) acting as an axle,
d) a means for partial coupling of the said tubular body C2 (4) and the said central body C1 (5) in rotation, rotation of the said tubular body C2 (4) only causing a rotation of the said central body C1 (5) during the said screwing step, rotation of the said central body C1 (5) possibly being interrupted by the development of an opposing torque C at the end of screwing,
e) the said central body C1 (5) comprises a bearing part C0 (6) that will cause rotation of the said cap (8) and move axially with respect to the said central body C1 (5) with a displacement D0 typically corresponding to the height of the (51) for the said bearing part (6) and a spring R0 (60) applying a force F0 on the said bearing part C0 (6) so as to provide coupling of the said capping head (2) through the said bearing part C0 (6) and the said cap (8) in rotation, and to form the said screwing means,
f) the said arms or lifting beams (40) of the said crimping means are axially fixed to the said tubular body C2 (4) and can be rotated due to a secondary rotation axis (44) typically fixed to the said tubular body C2(4).

8. Device according to claim 7 in which the said crimping means includes a cam (32) axially fixed to the said support C3 (3), each of the said typically rigid arms (40) comprising an upper part (400) typically provided with a caster or a wheel or a sliding pad (401), and a roller support arm (402) supporting the said roller (41), such that the said second displacement causes a temporary cooperation of the said cam (32) and the said wheel or pad (401), bringing the said roller (41) closer to the said neck (70) for the said crimping.

9. Device according to either claim 7 in which the said support C3 (3) of the said capping head (2) is solidarised to an arm (12), typically horizontal, and is free in rotation with respect to the said arm (12), the said support C3 (3) and the said arm (12) respectively forming an axle/hub assembly, the said arm (12) possibly acting as a support for a motor forming the said rotation means (13) capable of driving the said support C3 (3) in rotation.

10. Device according to claim 9 in which the said arm (12) and the said fixed frame (10) cooperate, typically using a vertical column (14) so as to assure the said axial displacement D3 of the support C3 (3) by translation of the said arm (12) in a vertical plane, typically by means of an auxiliary motor (11) acting as an axial displacement means.

11. Device according to claim 9 in which the said arm (12) is placed onboard a rotary turret and forms part of a set of n capping heads (2), where n typically varies from 2 to 12, the supports C3 (3) being engaged to a central gearwheel to rotate the said supports C3.

12. Device according to claim 7, in which the said partial rotational coupling means of the said tubular body C2 (4) and the said central body C1 (5) is a magnetic or electromagnetic coupling, typically by means of facing magnets (43, 50) supported by the said tubular body C2 (4) and the said central body C1 (5).

13. Device according to claim 7 in which, at the end of the screwing step, the said bearing part C0 (6) can be brought into contact with the said upper stop (51) so that the said central body C1 (5) and the said tubular body C2 (4) can transmit the said force F2 to the head (82) of the said cap (8).

14. Device according to claim 1, in which the rotation speed Ω and displacement speed V of the said capping head (2) during the said first displacement are slaved so as to satisfy the relation V=Hf.Ω/N so as to synchronise rotation of the said cap (8) and lowering it onto the neck (70) during the said screwing step, typical values of Hf, Ω and N being between 5 mm and 20 mm for Hf, between 150 rpm and 500 rpm for Ω, and between 10 and 25 turns for N.

15. Method of capping a bottle using the capping device (1) according to claim 1, in which the said capping head (2) screws and crimps a screw cap (8) on the threaded neck (70) of the said bottle or receptacle (7) and in which the said bottle (7) having firstly being brought facing the said head, typically by horizontal step by step displacement, or possibly continuous displacement, of the said bottle (7) and alignment of the said rotation axis (20) and the axis of symmetry (71) and held still for a time T corresponding to one capping cycle, the said head is subjected to a cyclic movement with duration T with respect to the said neck (70) typically including lowering of the said head from a high point to a low point, with a lowering time Td of the said head during which the said cap was firstly procured and placed on the said neck, the said screwing is carried out first during a time Tdv followed by the said crimping for a time Tds, the said lowering time Td being approximately equal to the time necessary to perform the said first and second displacements, followed by a rise time Tr of the said head, the said bottle after being capped being displaced and replaced by another bottle to be capped typically when the said head is at the said high point.

16. Method according to claim 15 in which the said cyclic movement of the said capping head (2) is a sinusoidal movement typically obtained by cooperation of a connecting rod and a crank.

17. Method according to claim 15 in which the said cyclic movement of the said head (2) is a continuous circular movement typically obtained using a cam.

18. Method according to claim 15 in which the said cyclic movement of the said head is a movement composed of linear parts at constant speed, typically obtained with hydraulic jacks.

19. Method according to claim 18 in which the rise time Tr may be shorter than the lowering time Td, and typically less than half as long.
